(19) United States
(12) Patent Application Publication
(10) Pub. No.: US 2026/0155481 A1
(43) Pub. Date: Jun. 4, 2026

(54) IMMERSION COOLING MODULE

(71) Applicants: SK INNOVATION CO., LTD., Seoul (KR); SK On Co., Ltd., Seoul (KR)

(72) Inventors: In Sik JUNG, Daejeon (KR); Gi Hong MIN, Daejeon (KR)

(21) Appl. No.: 19/408,380

(22) Filed: Dec. 4, 2025

(30) Foreign Application Priority Data
Dec. 4, 2024 (KR) 10-2024-0178694

(51) Int. Cl. H01M 10/6557; H01M 10/613; H01M 10/6567; H01M 50/204; H01M 50/291; H01M 50/293

(52) U.S. Cl. CPC H01M 10/6557; H01M 10/613; H01M 10/6567; H01M 50/291; H01M 50/293; H01M 50/204; H01M 2200/20

(57) ABSTRACT

Provided is an immersion cooling module including a housing configured to contain a cooling fluid, and a battery module submerged in the cooling fluid inside the housing, wherein the battery module includes a buffer member provided on stacked surfaces of battery cells and configured to have a buffer space into which an inflow of the cooling fluid is blocked by a rupture film.

### CROSS REFERENCE TO RELATED APPLICATION

The present application claims priority to Korean Patent Application No. 10-2024-0178694, filed Dec. 4, 2024, the entire contents of which are incorporated herein for all purposes by this reference.

### BACKGROUND

### Technical Field

The embodiments of the present disclosure relate generally to an immersion cooling module.

### Description of the Related Art

In recent years, as mobile devices such as mobile phones and laptops have become smaller and lighter, and electric vehicles and hybrid vehicles demand high-capacity power sources, a variety of batteries are being developed and used.

In the case of secondary batteries, efficiency is becoming increasingly important depending on the application field, but problems such as heat generation and fires during charging or operation may occur due to external factors.

Accordingly, technologies are being developed to increase the operating efficiency of secondary batteries and ensure safety. Moreover, a recent surge in electricity usage has led to increased carbon emissions and exacerbated global warming concerns, which has called for more efficient device operation mechanisms, and improved cooling methods and maximization of cooling efficiency therefor.

### SUMMARY

According to an embodiment of the present disclosure, provided is an immersion cooling module that implements immersion cooling for effectively cooling a battery module and effectively preventing thermal expansion and fire propagation in battery cells that make up the battery module.

In order to achieve the above objectives, according to an embodiment of the present disclosure, there is provided an immersion cooling module including a housing configured to contain a cooling fluid; and a battery module submerged in the cooling fluid inside the housing, wherein the battery module may include a buffer member provided on stacked surfaces of battery cells and configured to have a buffer space into which an inflow of the cooling fluid is blocked by a rupture film.

In this case, the buffer member may include the rupture film provided on one or both sides of upper and lower sides of the buffer space formed inside the buffer member, wherein the rupture film may be ruptured by a predetermined pressure due to contraction or relaxation of the buffer space, so that the cooling fluid may flow into the buffer space.

In addition, the buffer member may be provided on the stacked surfaces of the battery cells, may have the buffer space formed to cover some areas in a center of the stacked surfaces of the battery cells, and may include an extension portion extending upwards or downwards from the buffer space to support the stacked surfaces of the battery cells.

In addition, the rupture film may include a rupture portion provided on the rupture film to rupture by a predetermined pressure due to expansion or contraction of the battery cells, wherein the rupture portion may be provided with a relatively lesser thickness on the rupture film.

In addition, the rupture film may include a rupture portion provided on the rupture film to rupture by a predetermined pressure due to expansion or contraction of the battery cells, wherein the rupture portion may be provided on the rupture film, and may be made of a different material having a lower elongation than that of the rupture film.

In addition, the rupture film of the buffer member may include at least one rupture film.

According to another embodiment of the present disclosure, an immersion cooling module may be provided, the immersion cooling module comprising a housing configured to contain a cooling fluid and a battery module submerged in the cooling fluid inside the housing, wherein the battery module comprises a buffer member disposed between adjacent stacked battery cells, the buffer member including a buffer space defined by a buffer support wall and a rupture film forming at least one boundary of the buffer space blocking inflow of the cooling fluid, the rupture film including a rupture portion, the rupture portion being configured to break upon deformation of the buffer support wall so that the cooling fluid flows into the buffer space to cool the battery cells.

The features and advantages of the embodiments of the present disclosure will become more apparent from the following detailed description based on the accompanying drawings.

Terms or words used in this specification and claims should not be construed in their usual, dictionary meaning, and should be interpreted with meaning and concept consistent with the technical idea of the present disclosure on the basis of the principle that the inventor can define terminology appropriately to describe his or her invention in the best way possible.

According to an embodiment of the present disclosure, by submerging a battery module in a cooling fluid, cooling efficiency can be improved and physical deformation, such as from thermal expansion, of battery cells of the battery module can be effectively buffered.

Furthermore, when deformation due to thermal expansion in battery cells of a battery module exceeds a preset threshold, a cooling fluid is introduced into an area between the stacked surfaces of the battery cells to block heat transfer between the battery cells.

Furthermore, cooling efficiency for a battery module can be increased, and thermal expansion and fire propagation within the battery module can be effectively prevented.

Furthermore, by minimizing the risk of battery cell damage and effectively extending the lifespan of a device, it is possible to effectively reduce carbon emissions from electricity use by increasing overall energy efficiency and minimizing waste.

### BRIEF DESCRIPTION OF THE DRAWINGS

The above and other objectives, features, and other advantages of the embodiments of the present disclosure will be more clearly understood from the following detailed description when taken in conjunction with the accompanying drawings, in which:

FIG. 1 is a cross-sectional view of an immersion cooling module according to a first embodiment of a buffer member according to an embodiment of the present disclosure;

FIG. 2 is a cross-sectional view of an immersion cooling module according to a modified illustration of a first embodiment of a buffer member according to an embodiment of the present disclosure;

FIG. 3 is a perspective view of a battery module according to an embodiment of the present disclosure;

FIG. 4 is a cross-sectional view of a first embodiment of a buffer member according to an embodiment of the present disclosure;

FIG. 5 is a cross-sectional view of a modified illustration of a first embodiment of a buffer member according to an embodiment of the present disclosure;

FIG. 6 is a cross-sectional view of a second embodiment of a buffer member according to an embodiment of the present disclosure;

FIG. 7 is a cross-sectional view of a modified illustration of a second embodiment of a buffer member according to an embodiment of the present disclosure; and

FIG. 8 is a schematic view of the operation of a buffer member of an immersion cooling module according to an embodiment of the present disclosure.

### DETAILED DESCRIPTION

Terms used to describe embodiments of the present disclosure are not intended to limit the scope of this disclosure. It should be noted that singular expressions include plural expressions unless the context clearly dictates otherwise.

It should be noted that, in assigning reference numerals to components in the drawings, identical components are assigned the same reference numerals as much as possible even if they are shown in different drawings, and similar reference numbers are assigned to similar components.

The drawings may be schematic or exaggerated for the purpose of illustrating the embodiments. In the present disclosure, expressions such as “have”, “may have”, “include”, or “may include” refer to the presence of the corresponding feature (e.g., a numerical value, function, operation, or component such as a part), and do not exclude the presence of additional features.

Terms such as “one”, “other”, “another”, “first”, “second”, etc., are used to distinguish one component from another component, and the components are not limited by the terms.

Hereinafter, an embodiment of the present disclosure will be described in detail with reference to the attached drawings.

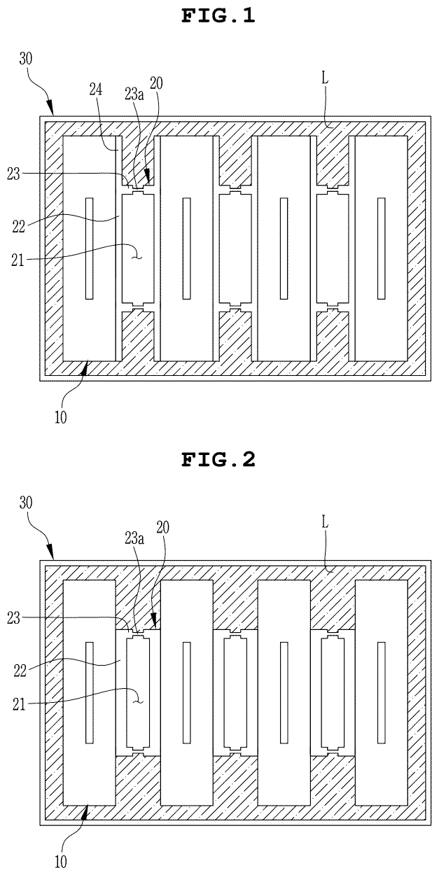

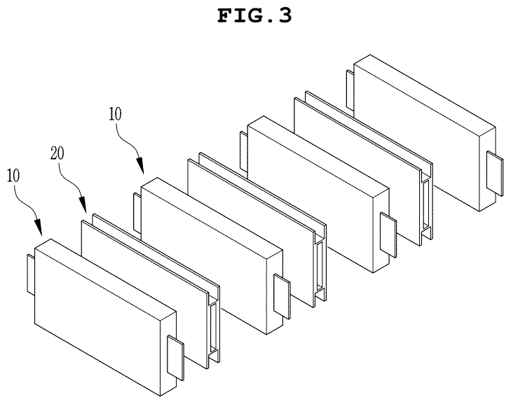

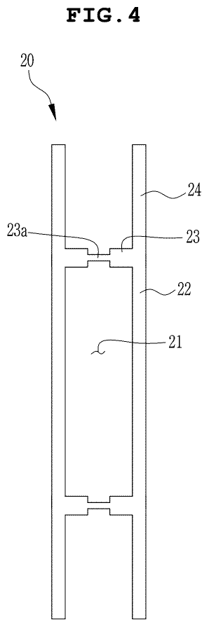

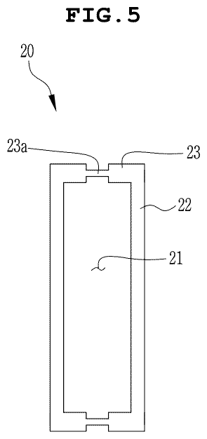

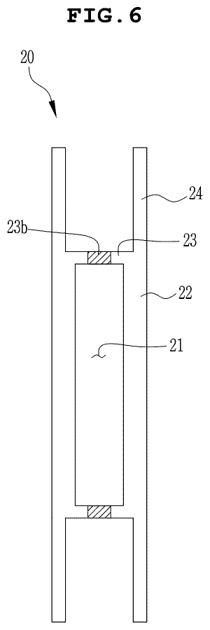

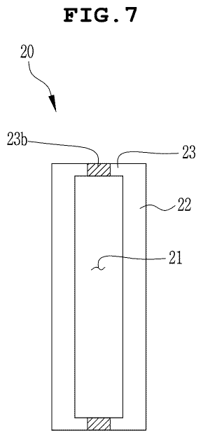

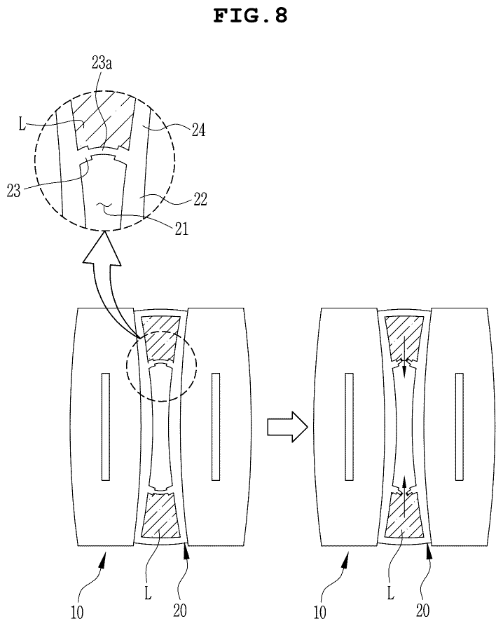

FIG. 1 is a cross-sectional view of an immersion cooling module according to a first embodiment of a buffer member 20 according to an embodiment of the present disclosure; FIG. 2 is a cross-sectional view of an immersion cooling module according to a modified illustration of the first embodiment of the buffer member 20 according to an embodiment of the present disclosure; FIG. 3 is a perspective view of a battery module according to an embodiment of the present disclosure; FIG. 4 is a cross-sectional view of the first embodiment of the buffer member 20 according to an embodiment of the present disclosure; FIG. 5 is a cross-sectional view of a modified illustration of the first embodiment of the buffer member 20 according to an embodiment of the present disclosure; FIG. 6 is a cross-sectional view of a second embodiment of the buffer member 20 according to an embodiment of the present disclosure; FIG. 7 is a cross-sectional view of a modified illustration of the second embodiment of the buffer member 20 according to an embodiment of the present disclosure; and FIG. 8 is a schematic view of the operation of the buffer member 20 of an immersion cooling module according to an embodiment of the present disclosure.

An immersion cooling module according to an embodiment of the present disclosure may include a housing 30 containing a cooling fluid L, and a battery module submerged in the cooling fluid L inside the housing 30. The battery module may include a buffer member 20 provided on the stacked surfaces of battery cells 10 and having a buffer space 21 into which the inflow of the cooling fluid L is blocked by a rupture film 23.

As shown in FIGS. 1 and 2, the immersion cooling module according to an embodiment of the present disclosure may cool the battery module by placing the battery module in the housing 30 containing the cooling fluid L.

The housing 30 accommodates the cooling fluid L inside, and may drive and cool the battery module by immersing the battery module in the cooling fluid L.

As the cooling fluid L, a non-conductive fluid may be used to prevent electricity from flowing through a battery module, an electronic product, or a server, etc., that is immersed. Base oil may also be applied as the cooling fluid L. The base oil may include mineral oil, polyalphaolefin (PAO), and/or ester base oil. However, the cooling fluid L of the present disclosure is not limited thereto, and any fluid that performs cooling of the battery cell 10 may be included.

As shown in FIG. 3, the buffer member 20 may be coupled to the stacked surfaces of battery cells 10.

By positioning the buffer member 20 between consecutive battery cells 10, the buffer member 20 may perform a buffering function between the battery cells 10 against physical expansion of the battery cells 10 or may effectively block and prevent heat transfer due to explosion or fire of the battery cells 10.

The buffer member 20 may be made of a material having a predetermined elasticity to buffer the physical expansion of the battery cell 10, and may be made of a material having insulating properties for electrical insulation.

The buffer member 20 may be formed of materials such as silicone-based elastomers, EPDM, FKM (fluoro-rubber), TPU, or other materials exhibiting excellent elasticity, electrical insulation, and chemical resistance.

The buffer member 20 may be provided between the stacked surfaces of battery cells 10, and when the battery module is submerged in the cooling fluid L, may prevent the cooling fluid L from flowing into the buffer space 21 formed therein by means of the rupture film 23. More specifically, the buffer member 20 is shaped to allow the consecutive stacked battery cells 10 to be placed adjacent to the buffer support wall 22 and also form the buffer space 21 defined by the support wall 22 and the rupture film 23. In the illustrated embodiment, of FIG. 1, the buffer space 21 has a generally rectangular shape from a side view which is defined by the buffer support wall 22 and two horizontal rupture films 23 forming the top and bottom faces of the buffer space 21. In the embodiment of FIG. 1 the buffer member 20 further comprises extension portions 24 extending vertically above and below the buffer space 21. The extension portions 24 are extensions of the buffer support wall 20. The buffer space 21 of the buffer member 20 may appropriately contain air, but gases that may cause fire cannot be applied, and may contain fire extinguishing substances for fire prevention.

The buffer space 21 may offer an effective buffering effect by securing a space in which a buffer support wall 22 constituting the buffer space 21 can be physically deformed in response to physical expansion or contraction of the battery cell 10, and by applying an insulating material to the buffer support wall 22 constituting the buffer space 21, electrical and chemical risks to the battery cells 10 may be blocked in advance.

In the buffer member 20, the buffer space 21 may be created by providing the rupture film 23 at each of the top and bottom of the buffer space 21.

As shown in FIG. 1, the rupture film 23 may be provided on the buffer member 20 such that one side thereof contacts the buffer space 21 and the other side thereof contacts the cooling fluid L. Due to the rupture film 23, the cooling fluid L does not flow into the buffer space 21 of the buffer member 20, and the cooling fluid L fills the upper and lower spaces surrounding the buffer member 20 to cool the stacked surfaces of the battery cells 10.

The buffer member 20 may be provided with the rupture film 23, and an extension portion 24 extending upwards or downwards from the rupture film 23 and closely contacting the facing surfaces of adjacent battery cells 10 regarding the stacked surfaces of the battery cells 10. Due to the extension portion 24, heat transfer between battery cells 10 due to explosion of a battery cell 10 may be completely blocked. The extension portion 24 may be formed integrally with the buffer member 20 or provided in a form combined with the buffer member 20 in the relevant area.

The extension portion 24 is configured to support a separate area from that supported by the buffer space 21, and as described later, may effectively block heat transfer between battery cells 10 in the remaining area other than the area supported by the buffer space 21 when the rupture film 23 of the buffer member 20 is ruptured and the buffer space 21 is reduced.

Alternatively, as shown in FIG. 2, the buffer member 20 may be provided in an area corresponding to the central portions of the stacked surfaces of adjacent battery cells 10, so that the cooling fluid L can freely flow into the remaining area between the stacked surfaces of the battery cells 10 where the buffer member 20 is not provided, and directly contact the stacked surfaces of the battery cells 10, thereby increasing cooling efficiency for the battery cells 10 at the upper and lower portions of the battery cells 10. In the embodiment of FIG. 2, the buffer member 20 does have the extension portions 24 of the embodiment illustrated in FIG. 1As shown in FIGS. 4 and 5, the rupture film 23 of the buffer member 20 may be broken by a predetermined pressure due to the expansion or contraction of a battery cell 10 when the battery cell 10 physically expands or the volume increases rapidly due to an explosion, etc. When the rupture film 23 that was blocking the inflow of the cooling fluid L into the buffer space 21 is ruptured, the cooling fluid L naturally flows into the buffer space 21. As the cooling fluid L flows into the buffer space 21, the rapid temperature increase between the stacked surfaces of the battery cells 10 may be alleviated, and the operational stability of the entire battery module or a device to which the battery module is applied may be secured from the risk of explosion of a battery cell 10.

The rupture film 23 of the buffer member 20 is configured to be cut or broken by the pressure generated when the buffer support wall 22 constituting the buffer space 21 experiences rapid physical change due to expansion or contraction of a battery cell. To this end, a rupture portion 23a may be provided on the rupture film 23 to control the cutting or breaking position or degree of the rupture of the rupture film 23.

As shown in FIGS. 4 and 5, the rupture portion 23a may be formed as a portion of the rupture film 23 but having a relatively lesser thickness than the rest of the rupture film 23. The rupture portion 23a of the rapture film 23 may be formed with a relatively lesser thickness in the rupture film 23 (meaning as a portion of the rupture film 23) to be more easily ruptured by external pressure applied. The relative thickness of the rupture portion 23a formed in the rupture film 23 may be appropriately determined based on the expected physical deformation range, which is influenced by the specifications or output characteristics of the battery module to which the buffer member 20 is applied.

In addition, as shown in FIGS. 6 and 7, in a different implementation of the rupture portion, the rupture portion 23b may be formed in the rupture film 23, but may be made of a different material having a relatively lower elongation than that of the rupture film 23. In addition, even in the case of using the same material rather than using a different material, the physical structure may be changed and applied to lower the elongation. Even if the same material is used, it is still possible to modify the physical design or geometry of the existing material to achieve different mechanical properties and in particular the elongation. Elongation refers to how much the material stretches under stress before breaking. By changing the structure (for example, thickness, layering, etc.) the material can be made stiffer and less prone to stretching. The higher the elongation of a material, the more flexibly the material can respond to deformation caused by external impact. Thus, by applying a structure or material with low elongation to a predetermined location of the rupture film 23 for the rupture portion 23b, the corresponding location where the rupture portion 23b of the rupture film 23 is formed may be preferentially broken by external pressure.

In case that the rupture portion 23b is formed in the rupture film 23 using a different material, the rupture portion 23b may be formed by joining the rupture portion 23b to the rupture film 23 at the location of rupture or, depending on the material, by manufacturing the rupture portion 23b to be joined to the rupture film 23 as one piece. The rupture portion (23b) can either be attached as a separate material at the rupture site or manufactured integrally with the rupture film, depending on the material's properties.

As shown, a single rupture film 23 may be provided, but a plurality of rupture film 23 may be provided in multiple stages depending on the degree of physical deformation applied, and thus in an embodiment of the present disclosure, at least one rupture film 23 may be provided.

To be specific, FIG. 8 shows a case where a physical deformation such as expansion occurs in battery cells 10 while the buffer member 20 is joined between the battery cells 10.

When the battery cells 10 expand in a state where the buffer member 20 is joined between the battery cells 10, the buffer space 21 of the buffer member 20 is reduced. As the buffer space 21 is reduced, the rupture film 23 is consequently broken due to physical deformation of the buffer support wall 22 of the buffer space 21. By forming the rupture portion 23a in the rupture film 23 the rupture portion 23a may be broken relatively more quickly. This mechanism prevents excessive pressure buildup within the battery system.

When the rupture portion 23a of the rupture film 23 is broken in this way, the cooling fluid L outside of the buffer space immediately flows into the buffer space 21 of the buffer member 20, thereby responding to a battery cell 10 fire or explosion. In addition, a double heat-insulating barrier may be formed by preventing heat transfer between battery cells 10 by utilizing the insulating properties or heat-insulating properties of the material that makes up the buffer member 20. Hence, the embodiments of the present disclosure further enable both rapid cooling response and enhanced thermal isolation between battery cells.

Above, specific embodiments of the present disclosure have been described in detail. The embodiments are only for illustration and do not limit the scope of the appended claims. It is apparent to those skilled in the art that various changes and modifications to the embodiments are possible within the scope and technical idea of the present disclosure, and it is natural that such changes and modifications fall within the scope of the appended claims. Furthermore, the embodiments may be combined to form additional embodiments.

What is claimed is:

1. An immersion cooling module comprising:
a housing configured to contain a cooling fluid; and
a battery module submerged in the cooling fluid inside the housing,
wherein the battery module comprises:
a buffer member provided on stacked surfaces of battery cells and configured to have a buffer space into which an inflow of the cooling fluid is blocked by a rupture film.

2. The module of claim 1, wherein the buffer member comprises:
the rupture film provided on one or both sides of upper and lower sides of the buffer space formed inside the buffer member,
wherein the rupture film is ruptured by a predetermined pressure due to contraction or relaxation of the buffer space, so that the cooling fluid flows into the buffer space.

3. The module of claim 1, wherein the buffer member is provided on the stacked surfaces of the battery cells, has the buffer space formed to cover some areas in a center of the stacked surfaces of the battery cells, and includes an extension portion extending upwards or downwards from the buffer space to support the stacked surfaces of the battery cells.

4. The module of claim 2, wherein the rupture film comprises:
a rupture portion provided on the rupture film to rupture by the predetermined pressure due to expansion or contraction of the battery cells,
wherein the rupture portion is provided with a lesser thickness on the rupture film.

5. The module of claim 2, wherein the rupture film comprises:
a rupture portion provided on the rupture film to rupture by the predetermined pressure due to expansion or contraction of the battery cells,
wherein the rupture portion is provided on the rupture film, and is made of a different material having a lower elongation than that of the rupture film.

6. The module of claim 2, wherein the rupture film of the buffer member includes at least one rupture film.

7. An immersion cooling module comprising:
a housing configured to contain a cooling fluid; and
a battery module submerged in the cooling fluid inside the housing,
wherein the battery module comprises:
a buffer member disposed between adjacent stacked battery cells, the buffer member including:
a buffer space defined by a buffer support wall,
a rupture film forming at least one boundary of the buffer space blocking inflow of the cooling fluid, the rupture film including a rupture portion, the rupture portion being configured to break upon deformation of the buffer support wall so that the cooling fluid flows into the buffer space to cool the battery cells.
